(19) United States
(12) Patent Application Publication
(10) Pub. No.: US 2025/0267273 A1
(43) Pub. Date: Aug. 21, 2025

(54) A METHOD, AN APPARATUS AND A COMPUTER PROGRAM PRODUCT FOR VIDEO ENCODING AND DECODING

(71) Applicant: Nokia Technologies Oy, Espoo (FI)

(72) Inventors: Ramin GHAZNAVI YOUVALARI, Tampere (FI); Miska Matias HANNUKSELA, Tampere (FI); Jani LAINEMA, Tampere (FI)

(21) Appl. No.: 19/116,321

(22) PCT Filed: Jun. 27, 2023
(86) PCT No.: PCT/FI2023/050394

§ 371 Date: Mar. 27, 2025

(30) Foreign Application Priority Data
Sep. 29, 2022 (FI) 20225860

(51) Int. Cl. H04N 19/137; H04N 19/105; H04N 19/176

(52) U.S. Cl. CPC H04N 19/137; H04N 19/105; H04N 19/176

(57) ABSTRACT

The present embodiments relate to a method for encoding and a technical equipment for implementing the method. The method comprises determining (1610) a motion vector and a reference frame for a current block; determining (1620) when the motion vector points to an area outside of the reference frame; generating (1630) an extended reference frame by filling areas outside of the reference frame by one or more of the following: directional intra prediction using boundary samples of the reference frame according to a direction of the motion vector, intra prediction methods using decoded samples inside a current frame, intra predicted samples of the current block; predicting (1640) the current block by using motion compensation from the extended reference frame; and encoding (1650) the current block into a bitstream.

### TECHNICAL FIELD

The present solution generally relates to video encoding and video decoding. In particular, the present solution relates to motion compensation in video encoding and decoding.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for determining a motion vector and a reference frame for a current block; means for determining when the motion vector points to an area outside of the reference frame; means for generating an extended reference frame by filling areas outside of the reference frame by one or more of the following:
directional intra prediction using boundary samples of the reference frame according to a direction of the motion vector;
intra prediction methods using decoded samples inside a current frame;
intra predicted samples of the current block;

means for predicting the current block by using motion compensation from the extended reference frame; and means for encoding the current block into a bitstream.

According to a second aspect, there is provided a method, comprising: determining a motion vector and a reference frame for a current block; determining when the motion vector points to an area outside of the reference frame; generating an extended reference frame by filling areas outside of the reference frame by one or more of the following:
directional intra prediction using boundary samples of the reference frame according to a direction of the motion vector;
intra prediction methods using decoded samples inside a current frame;
intra predicted samples of the current block;
predicting the current block by using motion compensation from the extended reference frame; and encoding the current block into a bitstream.

According to a third aspect, there is provided an apparatus comprising at least one processor, memory including computer program code, the memory and the computer program code configured to, with the at least one processor, cause the apparatus to perform at least the following: determine a motion vector and a reference frame for a current block; determine when the motion vector points to an area outside of the reference frame; generate an extended reference frame by filling areas outside of the reference frame by one or more of the following:
directional intra prediction using boundary samples of the reference frame according to a direction of the motion vector;
intra prediction methods using decoded samples inside a current frame;
intra predicted samples of the current block;

predict the current block by using motion compensation from the extended reference frame; and encode the current block into a bitstream.

According to a fourth aspect, there is provided computer program product comprising computer program code configured to, when executed on at least one processor, cause an apparatus or a system to: determine a motion vector and a reference frame for a current block; determine when the motion vector points to an area outside of the reference frame; generate an extended reference frame by filling areas outside of the reference frame by one or more of the following:)
directional intra prediction using boundary samples of the reference frame according to a direction of the motion vector;
intra prediction methods using decoded samples inside a current frame;
intra predicted samples of the current block;

predict the current block by using motion compensation from the extended reference frame; and encode the current block into a bitstream.

According to an embodiment, the intra prediction methods are determined by using a texture analysis method.

According to an embodiment, the texture analysis method is a decoder side intra mode derivation method.

According to an embodiment, the intra prediction methods are determined by using a template based intra mode derivation method.

According to an embodiment, samples for the areas outside of the picture are predicted by cross-component prediction, where samples in the areas outside of the picture in the reference channel are used for predicting samples for the areas outside of the picture in the current channel.

According to an embodiment, border samples between the intra prediction and a motion compensation prediction are filtered in a final prediction. According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of the location of the left and above samples of a current block involved in the CCLM mode.

FIG. 2a shows an example of derivation of chroma prediction mode from luma mode when CCLM is enabled.

FIG. 2b shows an example of a unified binarization table for chroma prediction mode.

FIG. 3a shows two luma-to-chrome models obtained for luma Y threshold of 17.

FIG. 3b shows an example of correspondence of each luma-to-chroma model to a spatial segmentation of the content.

FIG. 4 shows an example of locations of the samples used for the derivation of CCCM filter.

FIG. 5 shows examples of various filter kernels;

FIG. 6 shows an example of four reference lines neighboring to a prediction block.

FIG. 7 shows an example an example of matrix weighted intra prediction process.

FIG. 8 shows an example of HoG computation from a template of width 3 pixels.

FIG. 9 shows an example of a low-frequency Non-Separable Transform (LFNST) process.

FIG. 10 shows an example of using intra prediction for generating the OOB area samples.

FIG. 11 shows an example of predicting only a portion of the OOB area samples.

FIG. 12 shows an example of a motion vector of a block pointing to OOB areas in reference frame.

FIG. 13 shows an example of combining motion compensated prediction and intra prediction from neighboring reference samples when motion vectors point to OOB areas in reference frame.

FIG. 14 shows an example an example where motion compensated samples are used along with the reconstructed reference samples.

FIG. 15 shows an example of directionally padding the OOB area samples in the reference picture.

FIG. 16 is a flowchart illustrating a method according to an embodiment.

FIG. 17 shows an apparatus according to an embodiment.

FIG. 18 shows an encoding process according to an embodiment.

FIG. 19 shows a decoding process according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

In the following, several embodiments will be described in the context of one video coding arrangement. It is to be noted, however, that the present embodiments are not necessarily limited to this particular arrangement. The embodiments relate to 15 border samples in motion compensation and ways to handle them.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance of Open Media (AOM). The AV1 specification was published in 2018. AOM is reportedly working on the AV2 specification.

Some key definitions, bitstream and coding structures, and concepts of H.264/AVC, HEVC, VVC, and/or AV1 and some of their extensions are described in this section as an example of a video encoder, decoder, encoding method, decoding method, and a bitstream structure, wherein the embodiments may be implemented. The aspects of various embodiments are not limited to H.264/AVC, HEVC, VVC, and/or AV1 or their extensions, but rather the description is given for one possible basis on top of which the present embodiments may be partly or fully realized.

A video codec may comprise an encoder that transforms the input video into a compressed representation suited for storage/transmission and a decoder that can uncompress the compressed video representation back into a viewable form. The compressed representation may be referred to as a bitstream or a video bitstream. A video encoder and/or a video decoder may also be separate from each other, i.e., need not form a codec. The encoder may discard some information in the original video sequence in order to represent the video in a more compact form (that is, at lower bitrate). The notation “(de) coder” means an encoder and/or a decoder.

Hybrid video codecs, for example ITU-T H.263, H.264/AVC and HEVC, may encode the video information in two phases. At first, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. Inter prediction may reduce temporal redundancy.

Intra prediction, where pixel of sample values can be predicted by spatial mechanisms, involve finding and indicating a spatial region relationship. Intra prediction utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

In syntax prediction, which may also be referred to as parameter prediction, syntax elements and/or syntax element values and/or variables derived from syntax elements are predicted from syntax elements (de) coded earlier and/or variable derived earlier. Non-limiting examples of syntax prediction are provided below.

In motion vector prediction, motion vectors e.g., for inter and/or inter-view prediction may be coded differentially with respect to a block-specific predicted motion vector. In many video codecs, the predicted motion vectors are created in a predefined way, for example, by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted from adjacent blocks and/or co-located blocks in temporal reference picture. Differential coding of motion vectors may be disabled across slice boundaries. The block partitioning, e.g., from a coding tree unit (CTU) to coding units (CUs) and down to prediction units (PUs), may be predicted.

In filter parameter prediction, the filtering parameters, e.g., for sample adaptive offset may be predicted.

Prediction approaches using image information from a previously coded image can also be called as inter prediction methods which may also be referred to as temporal prediction and motion compensation.

Prediction approaches using image information within the same image can also be called as intra prediction methods.

Secondly, the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients an entropy coding the quantized coefficients. By varying the fidelity of the quantization process, encoder can control the balance between the accuracy of the pixel representation (picture quality) and size of the resulting coded video representation (file size of transmission bitrate).

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g., in a coded bitstream e.g., using the Video Usability Information (VUI) syntax of HEVC or alike. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

Motion information may be indicated with motion vectors associated with each motion compensated image block in video codecs. Each of these motion vectors represents the displacement of the image block in the picture to be coded (in the encoder side) or decoded (in the decoder side) and the prediction source block in one of the previously coded or decoded images (or pictures). H.264/AVC and HEVC, as many other video compression standards, a picture is divided into a mesh of rectangles, for each of which a similar block in one of the reference pictures is indicated for inter prediction. The location of the prediction block is coded as a motion vector that indicates the position of the prediction block relative to the block being coded.

A bitstream may be defined as a sequence of bits or a sequence of syntax structures. A bitstream format may constrain the order of syntax structures in the bitstream.

A syntax element may be defined as an element of data represented in the bitstream. A syntax structure may be defined as zero or more syntax elements present together in the bitstream in a specified order.

In some coding formats or standards, a bitstream may be in the form of a network abstraction layer (NAL) unit stream or a byte stream, that forms the representation of coded pictures and associated data forming one or more coded video sequences.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A NAL unit comprises a header and a payload. The NAL unit header indicates the type of the NAL unit among other things.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

In the following, partitioning a picture into subpictures, slices, and tiles according to H.266/VVC is described more in detail. Similar concepts may apply in other video coding specifications too.

A picture is divided into one or more tile rows and one or more tile columns. A tile is a sequence of coding tree units (CTU) that covers a rectangular region of a picture. The CTUs in a tile are scanned in raster scan order within that tile.

A slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which consists of an integer number of consecutive complete CTU rows within the tile.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture may be defined as a rectangular region of one or more slices within a picture, wherein the one or more slices are complete. Thus, a subpicture consists of one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices.

One or both of the following conditions may be required to be fulfilled for each subpicture and tile: i) All CTUs in a subpicture belong to the same tile. ii) All CTUs in a tile belong to the same subpicture.

In the following, partitioning a picture into tiles and tile groups according to AV1 is described more in detail. Similar concepts may apply in other video coding specifications too.

A tile consists of an integer number of complete superblocks that collectively form a complete rectangular region of a picture. In-picture prediction across tile boundaries is disabled. The minimum tile size is one superblock, and the maximum tile size in the presently specified levels is 4096×2304 in terms of luma sample count. The picture is partitioned a tile grid into one or more tile rows and one or more tile columns. The tile grid may be signalled in the picture header to have a uniform tile size or nonuniform tile size, where in the latter case the tile row heights and tile column widths are signalled. The superblocks in a tile are scanned in raster scan order within that tile.

A tile group OBU carries one or more complete tiles. The first and last tiles of in the tile group OBU may be indicated in the tile group OBU before the coded tile data. Tiles within a tile group OBU may appear in a tile raster scan of a picture.

Features and coding tools included in VVC include the following:
Intra prediction
   67 intra modes with wide angles mode extension
   Block size and mode dependent 4 tap interpolation filter
   Position dependent intra prediction combination (PDPC)
   Cross component linear model intra prediction (CCLM)
   Multi-reference line intra prediction
   Intra sub-partitions
   Weighted intra prediction with matrix multiplication
Inter-picture prediction
   Block motion copy with spatial, temporal, history-based, and pairwise average merging candidates
   O Affine motion inter prediction
   Sub-block based temporal motion vector prediction
   Adaptive motion vector resolution
   8×8 block-based motion compression for temporal motion prediction
   High precision ( 1/16pel) motion vector storage and motion compensation with 8-tap interpolation filter for luma component and 4-tap interpolation filter for chroma component
   Triangular partitions
   Combined intra and inter prediction
   Merge with MVD (MMVD)
   Symmetrical MVD coding
   Bi-directional optical flow
   Decoder side motion vector refinement
   Bi-prediction with CU-level weight
Transform, quantization and coefficient coding
   Multiple primary transform selection with DCT2, DST7 and DCT8
   Secondary transform for low frequency zone
   Sub-block transform for inter predicted residual
   Dependent quantization with max QP increased from 51 to 63
   Transform coefficient coding with sign data hiding
   Transform skip residual coding
Entropy coding
   Arithmetic coding engine with adaptive double windows probability update
In loop filter
   In-loop reshaping
   Deblocking filter with strong longer filter
   Sample adaptive offset
   Adaptive Loop Filter
Screen content coding
   Current picture referencing with reference region restriction
360-degree video coding
   Horizontal wrap-around motion compensation
High-level syntax and parallel processing
   Reference picture management with direct reference picture list signalling
   Tile groups with rectangular shape tile groups

In H.266/VVC, the following block partitioning applies. Pictures are partitioned into CTUs. A picture may also be divided into slices, tiles, bricks and subpictures. A CTU may be split into smaller CUs using quaternary tree structure. Each CU may be divided using quad-tree and nested multi-type tree including ternary and binary split.

There are specific rules to infer partitioning in picture boundaries.

The redundant split patterns are disallowed in nested built-type partitioning.

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β$$

where pred_{C}(i, j) represents the predicted chroma samples in a CU and rec_{L}′ (i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM mode is applied;
W′=W+H when LM-A mode is applied;
H′=H+W when LM-L mode is applied.

The above neighboring positions are denoted as S [0,−1] . . . . S [W′−1,−1] and the left neighbouring positions are denoted as S [−1, 0] . . . . S [−1, H′−1]. Then the four samples are selected as
S [W′/4,−1], S [3*W′/4,−1], S [−1, H′/4], S [−1, 3*H′/4] when LM mode is applied and both above and left neighbouring samples are available;
S [W′/8,−1], S [3*W′/8,−1], S [5*W′/8,−1], S [7*W′/8,−1] when LM-A mode is applied or only the above neighboring samples are available;
S [−1, H′/8], S [−1, 3*H′/8], S [−1, 5*H′/8], S [−1, 7*H′/8] when LM-L mode is applied or only the left neighboring samples are available.

The four neighboring luma samples at the selected positions are down-sampled and compared four times to find two smaller values: x0A and x1A, and two larger values: x0B and x1B. Their corresponding chroma sample values are denoted as y0A, y1A, y0B and y1B. Then xA, xB, yA and yB are derived as
Xₐ=(x⁰_{A}+x¹_{A}+1)»1; X_{b}=(x⁰_{B}+x¹_{B}+1)»1; Yₐ=(y⁰_{A}+y¹_{A}+1)»1; Y_{b}=(y⁰_{B}+y¹_{B}+1)»1

Finally, the linear model parameters are obtained according to the following equations:

$$α = \frac{{Y}_{a} - {Y}_{b}}{{X}_{a} - {X}_{b}}$$

$$β = {Y}_{b} - α \cdot {X}_{b}$$

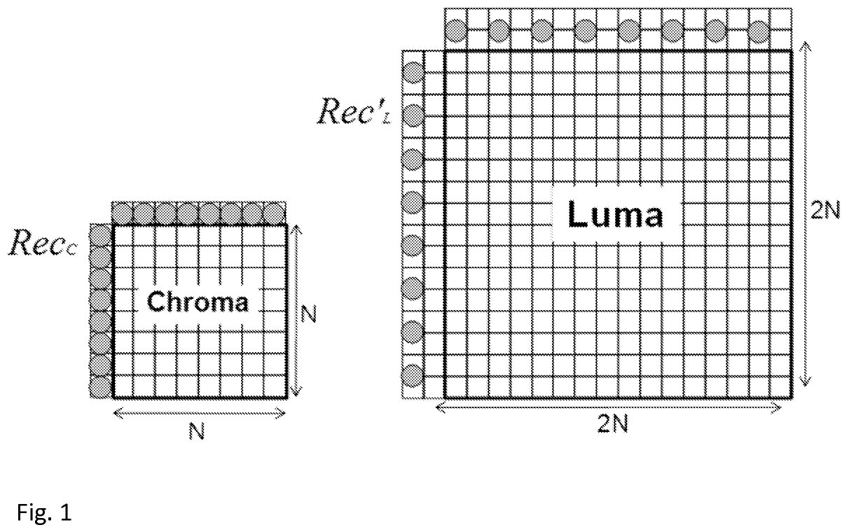

FIG. 1 shows an example of the location of the left and above samples and the sample of the current block involved in the CCLM mode. The division operation to calculate parameter α is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significant as follows:

DivTable [ ]={0, 7, 6, 5, 5, 4, 4, 3, 3, 2, 2, 1, 1, 1, 1, 0}

This would have a benefit of both reducing the complexity of the calculation as well as the memory size required for storing the needed tables.

Besides the above template and left template can be used to calculate the linear model coefficients together, they can also be used alternatively in the other 2 LM modes, called LM_A, and LM_L modes.

In LM_A mode, only the above template is used to calculate the linear model coefficients. To get more samples, the above template is extended to (W+H). In LM_L mode, only left template is used to calculate the linear model coefficients. To get more samples, the left template is extended to (H+W).

For a non-square block, the above template is extended to W+W, the left template is extended to H+H.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) \qquad = [ \begin{matrix}{rec}_{L} ( 2 i − 1 , 2 j − 1 ) + 2 \cdot {rec}_{L} ( 2 i − 1 , 2 j − 1 ) + {rec}_{L} ( 2 i + 1 , 2 j − 1 ) + \\ {rec}_{L} ( 2 i − 1 , 2 j ) + 2 \cdot {rec}_{L} ( 2 i , 2 j ) + {rec}_{L} ( 2 i + 1 , 2 j ) + 4\end{matrix} ] ≫ 3$$

$${rec}_{L}^{′} ( i , j ) \qquad = [ \begin{matrix}{rec}_{L} ( 2 i , 2 j − 1 ) + {rec}_{L} ( 2 i − 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3$$

It is appreciated that only one luma line (general line buffer in intra prediction) is used to make the down-sampled luma samples when the upper reference line is at the CTU boundary.

This parameter computation is performed as part of the decoding process and is not just as an encoder search operation. As a result, no syntax is used to convey the α and B values to the decoder.

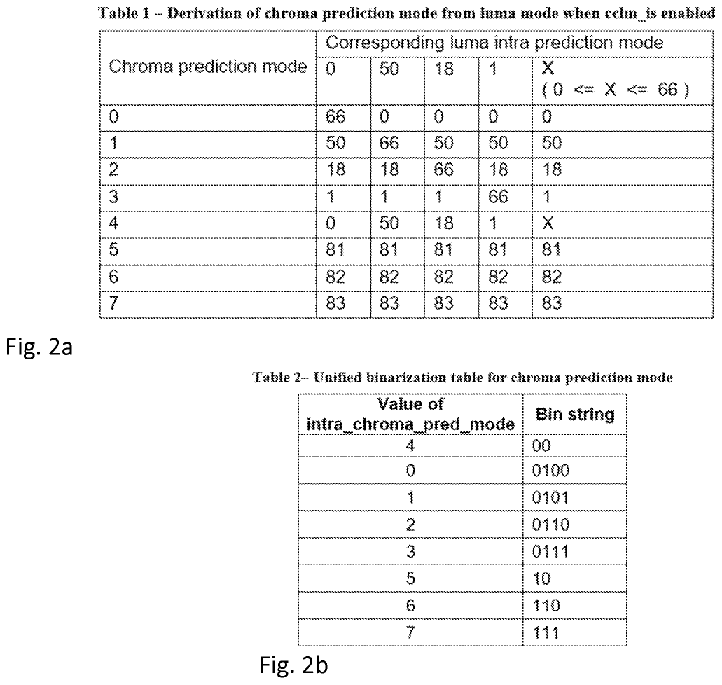

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in Table 1 in FIG. 2a. Chroma mode coding directly depends on the intra prediction of the corresponding luma block. Since separate block partitioning structure for luma and chroma components is enable in I slices, one chroma block may correspond to multiple luma blocks. Therefore, for Chroma DM mode, the intra prediction mode of the corresponding luma block covering the center position of the current chroma block is directly inherited.

A single binarization table is used regardless of the values of sps_cclm_enabled_flag as shown in Table 2 in FIG. 2b. In Table 2, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bines in Table 3-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×17 child node does not split or use Vertical BT split, all chroma CUs in the 32×16 chroma node can use CCLM.

In all the other luma and chroma coding tree split conditions, CCLM is not allowed for chroma CU.

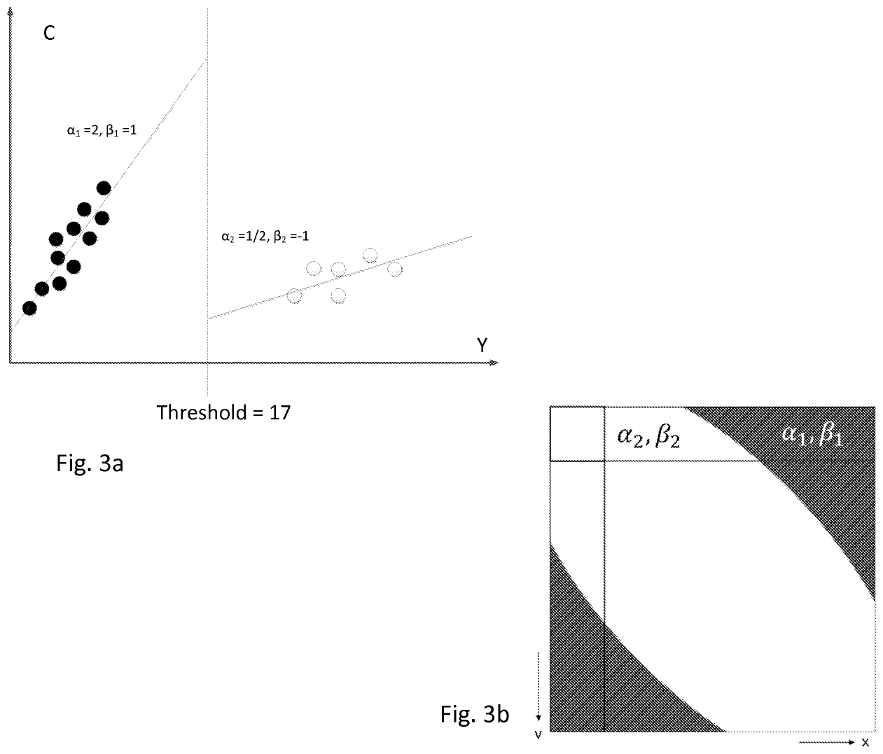

The CCLM included in VVC is extended by adding three Multi-model LM (MMLM) modes. In each MMLM mode, the reconstructed neighbouring samples are classified into two classes using a threshold which is the average of the luma reconstructed neighboring samples. The linear model of each class is derived using the Least-Mean-Square (LMS) method. For the CCLM mode, the LMS method is also used to derive the linear model. FIG. 3a illustrates two luma-to-chroma models obtained for luma (Y) threshold of 17. Each luma-to-chroma model has its own linear model parameters α and β. As can be seen from FIG. 3b, each luma-to-chroma model corresponds to a spatial segmentation of the content (i.e., they correspond to different objects or textures in the scene).

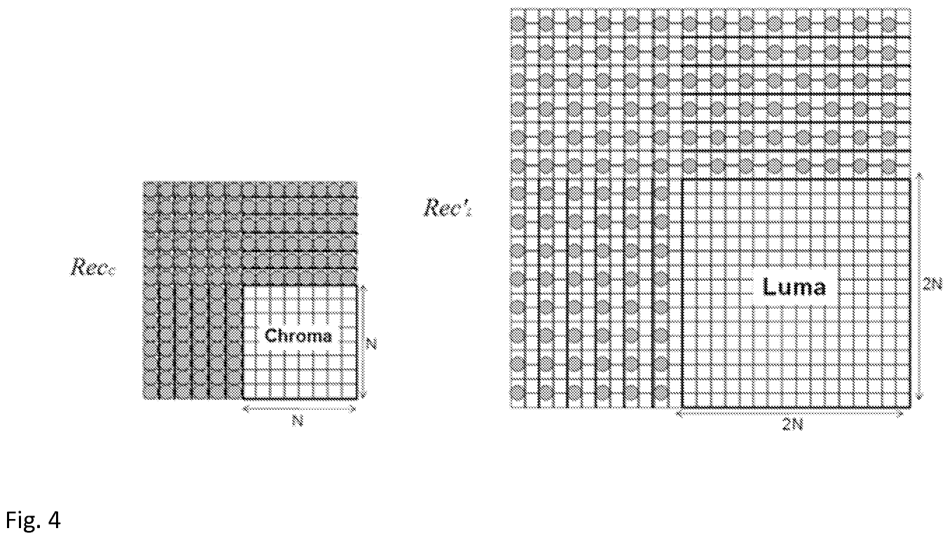

An improved version of cross-component prediction, known as convolutional cross-component model (CCCM), uses 2D filter kernel to derive the luma-to-chroma model. The filter coefficients are derived decoder-side using reconstructed set of input data and chroma samples. For the filter coefficient derivation, co-located reference sample areas (consisting of reconstructed luma and chroma samples) are defined for both luma and chroma as shown in FIG. 4, yet any number of reference lines (that can be realized by both the encoder and decoder) can be used. Generally, reference samples can contain any chroma and luma samples that have been reconstructed by both the encoder and decoder. Once the reference samples have been determined, the filter coefficients can be derived, for example, using different types of linear regression tools such as ordinary least-squares estimation, orthogonal matching pursuit, optimized orthogonal matching pursuit, ridge regression, or least absolute shrinkage and selection operator.

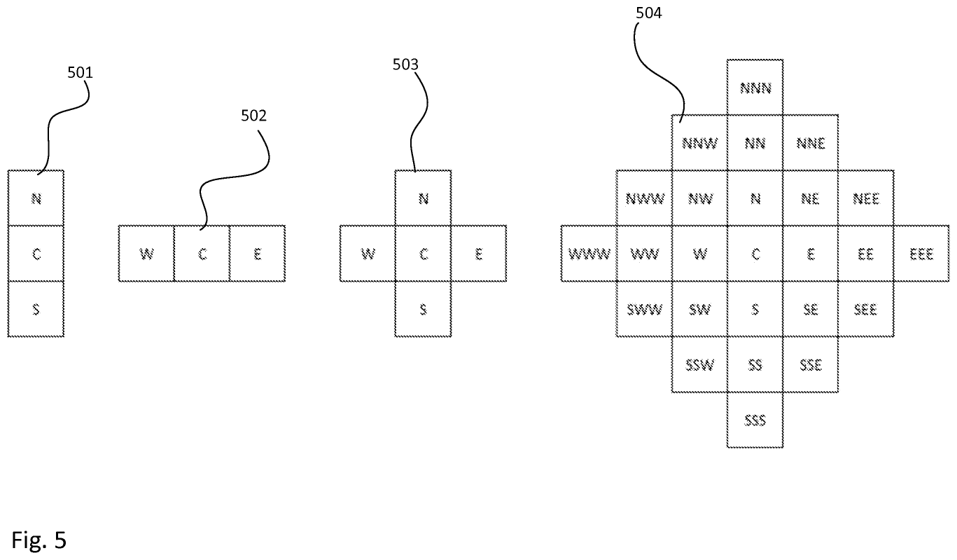

The dimensions of the filter kernel can be for example 1×3 (1D vertical), 3×1 (1D horizontal), 3×3, 7×7 or any dimensions, and can be shaped (by selecting only a subset of all possible kernel locations) as a cross or a diamond or as any given shape. When referring to the samples within the filter kernel, the following notation is used: north (above), east (right), south (below), west (left) and center, as illustrated in FIG. 5 using the letters N, E, S, W, C. FIG. 5 illustrate a 3-tap vertical kernel 501, 3-tap horizontal kernel 502, 5-tap cross kernel 503 and 25-tap diamond kernel 504.

The overall method of reconstructing chroma samples using convolution between a decoder-side obtained filter kernel and a set of input data is referred to as convolutional cross-component model (CCCM) here. The following steps can be applied to perform a CCCM operation:
Define co-located reference areas over the luma and chroma components;
Down-sample the luma samples to match the chroma grid (optional);
Scan the luma and chroma samples of the reference area and collet available statistics (such as auto-correlation matrix and cross-correlation vector) based on the filter shape;
Solve the filter coefficients by minimizing squared-error (or any other metric) based on the available statistics (such as the auto-correlation matrix and cross-correlation vector);
Calculate a predicted chroma block by convolving the down-sampled luma samples with the filter kernel.

In the following, the (possibly down-sampled) luma samples are defined as a 2D array Y (x, y) indexed using horizontal x-coordinate and vertical y-coordinate. Also, the co-located chroma samples are defined as a 2D array C (x, y) and the filter kernel (i.e., coefficients) as 3×3 array F (i, j). On a sample level, the convolution between Y and F is defined as

$$( x , y ) = {\sum }_{j = - 1}^{j = 1} {\sum }_{i = - 1}^{i = 1} Y ( x + i , y + j ) \cdot F ( i + 1 , j + 1 ) .$$

When using other data terms, such as the non-linear square-root term, the appended convolution becomes

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) \cdot \sqrt{Y ( x , y )} ,$$

where \hat{F} are filter coefficients that reside outside of the 2D filter kernel yet have been obtained as a part of the system of linear equations that were used to solve the 2D filter coefficients in Step 4 above. Similarly, the bias term can be added to the convolution with

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) + \hat{F} ( 1 ) \cdot \sqrt{Y ( x , y )} .$$

Angular intra prediction (a.k.a. directional intra prediction) may be performed by extrapolating sample values from the reconstructed reference samples utilizing a given directionality. The reference samples may comprise the immediately neighboring sample row above and above-right of the current block (when available) and the immediately neighboring sample column on the left of the current block (when available), wherein availability may require decoding order earlier than that of the current block and presence in the same image segment, such as in the same tile. In order to simplify the process, all sample locations within one prediction block may be projected to a single reference row or column depending on the directionality of the selected prediction mode. A predicted sample within the block being encoded/decoded may be obtained by the following steps:
Projecting the location of a predicted sample to a location within a reference row or column by applying the selected prediction direction. The location within the reference row or column may have fractional sample accuracy, such as 1/32 pixel accuracy.
Interpolating a value for the sample location on the reference row or column from the reference samples at the reference row/column.

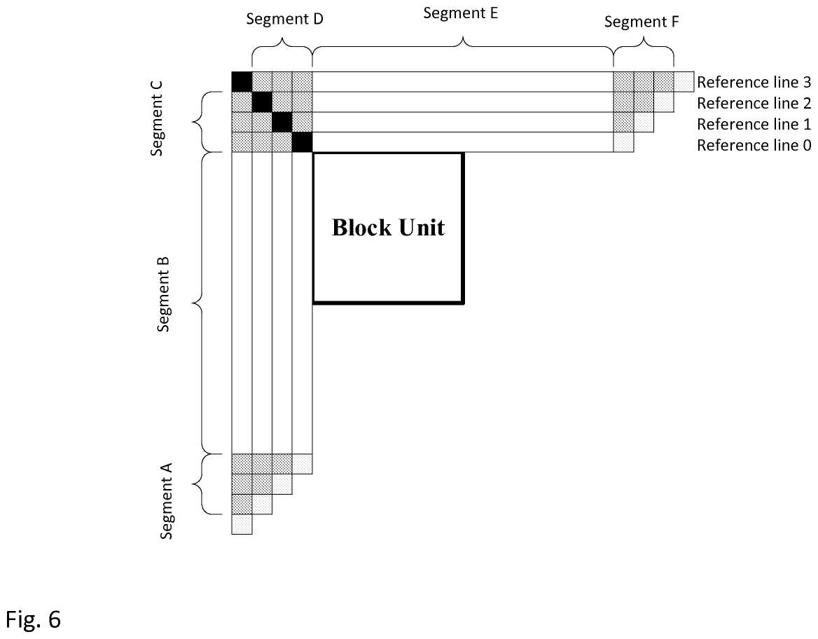

Multiple reference line (MRL) intra prediction uses more reference lines for intra prediction. In FIG. 6, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signaled and used to generate intra predictor. For reference line idx, which is greater than 0, only include additional reference line modes in MPM list and only signal mpm index without remaining mode. The reference line index is signaled before intra prediction modes, and Planar mode is excluded from intra prediction modes in case a nonzero reference line index is signaled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighboring luma reference lines for its own down-sampling filters. The definition of MLR to use the same 3 lines is aligned as CCLM to reduce the storage requirements for decoders.

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4), then the corresponding block is divided by 4 sub-partitions. It has been noticed that the M×12 (with M≤64) and 128×N (with N≤64) ISP blocks could generate a potential issue with the 64×64 VDPU. For example, and M×128 CU in the single tree case has an M×128 luma TB and two corresponding M/2×64 chroma TBs. If the CU uses ISP, then the luma TB will be divided into four M×32 TBs (only the horizontal split is possible), each of them smaller than a 64×64 block. However, in the current design of ISP, chroma blocks are not divided. Therefore, both chroma components will have a size greater than a 32×32 block.

Analogously, a similar situation could be created with a 128×N CU using ISP. Hence, these two cases are an issue for the 64×64 decoder pipeline. For this reason, the CU sizes that can use ISP is restricted to a maximum 64×64. All sub-partitions fulfil the condition of having at least 16 samples.

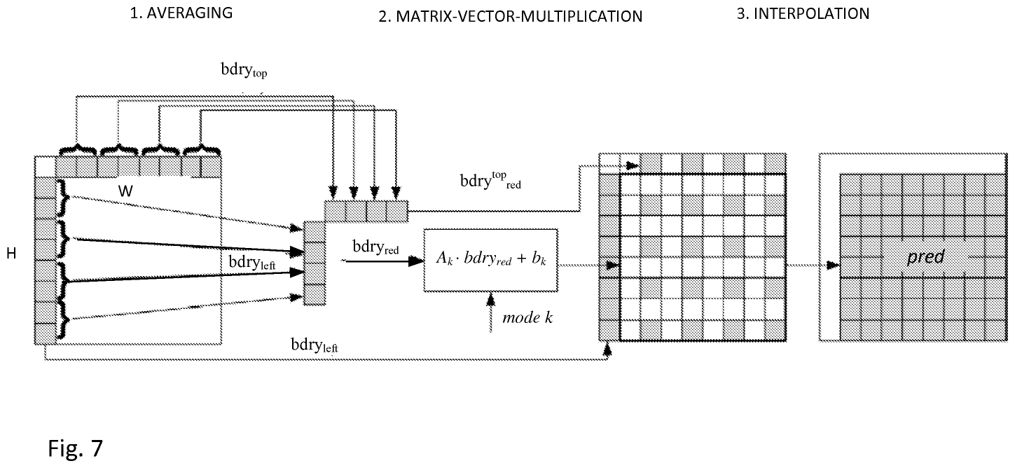

Matrix weighted intra prediction (MIP) method is an intra prediction technique in VVC. For predicting the samples of a rectangular block of width W and height H, matrix weighted intra prediction (MIP) takes one line of H reconstructed neighbouring boundary samples left of the block and one line of W reconstructed neighboring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 7.

When Decoder side intra mode derivation (DIMD) is applied, two intra modes are derived from the reconstructed neighbor samples, and those predictors are combined with the planar mode predictor with the weights derived from the gradients. The division operations in weight derivation is performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( G x ) )$$

$$normDiff = ( ( Gx << 4 ) >> x ) \& 15$$

$$x += ( 3 + ( normDiff != 0 ) ? 1 : 0 )$$

$$Orient = ( Gy ⋆ ( DivSigTable [ normDiff ] \vert 8 ) + ( 1 << ( x - 1 ) ) ) >> x$$

where
DivSigTable [16]={0, 7, 6, 5,5, 4, 4, 3, 3, 2, 2, 1, 1, 1, 1, 0}.

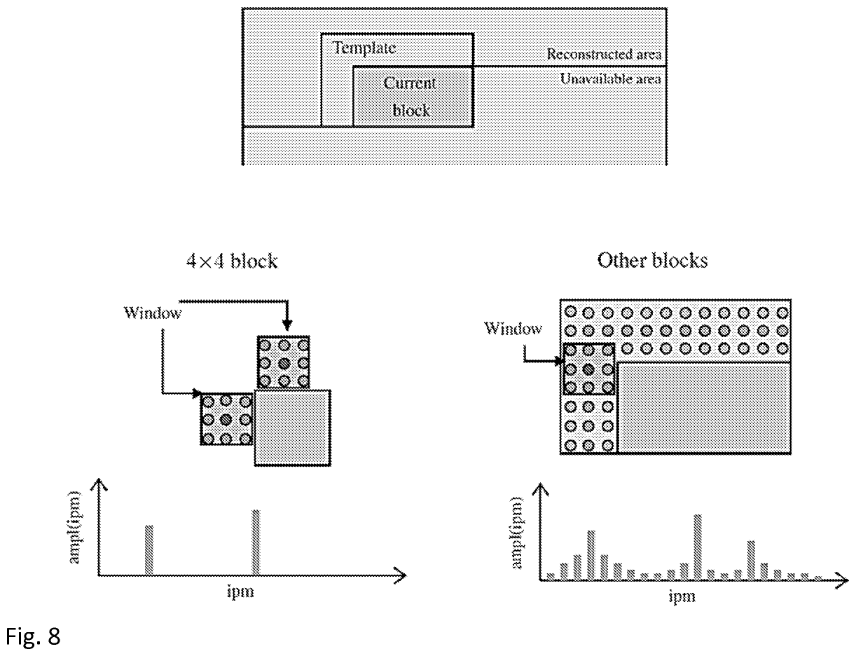

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks. FIG. 8 illustrates an example of HoG (Histogram of Oriented Gradients) calculation from a template of width 3 pixels.

For each intra prediction mode in MPMs, the sum of absolute transformed differences (SATD) between the prediction and reconstruction samples of the template are calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes. The costs of the two selected modes are compared with a threshold, in the test of the cost factor of 2 is applied as follows:

$$costMode 2 < 2 ⋆ costMode 1$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

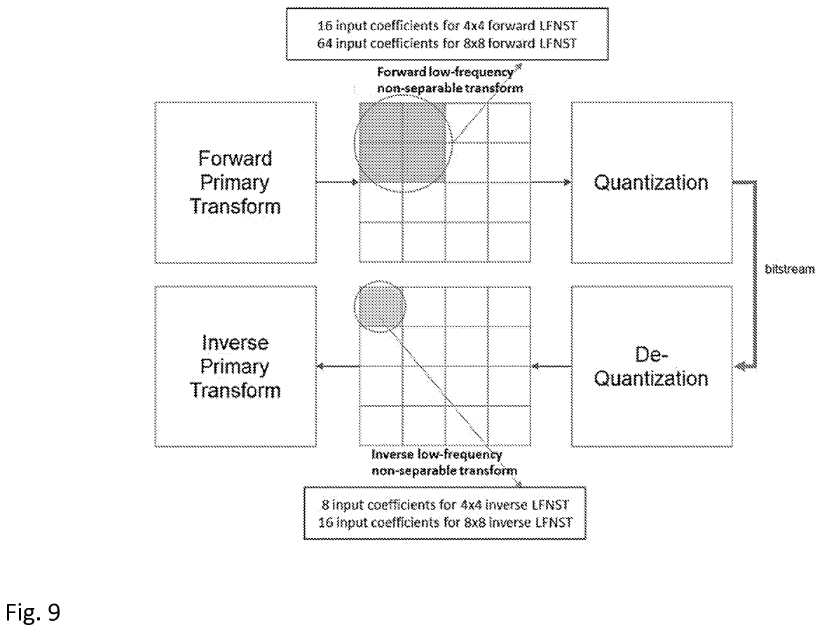

In VVC, Low-frequency non-separable transform (LFNST) is applied between forward primary transform and quantization (at encoder) and between de-quantization and inverse primary transform (at decoder side) as shown in FIG. 9. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{32}\end{matrix} ]$$

is first represented as a vector X:
[symbol] = [X₀₀ X₀₁ X₀₂ X₀₃ X₁₀ X₁₁ X₁₂ X₁₃ X₂₀ X₂₁ X₂₂ X₂₃ X₃₀ X₃₁ X₃₂ X₃₃]^{T}

The non-separable transform is calculated as [symbol] =T· [symbol] where [symbol] indicates the transform coefficient vector, and T is a 16×16 transform matrix. The 16×1 coefficient vector \hat{F} is subsequently reorganized as 4×4 block using the scanning order for that block (horizontal, vertical or diagonal). The coefficients with smaller index will be placed with the smaller scanning index in the 4×4 coefficient block.

LFNST is based on direct matrix multiplication approach to apply non-separable transform so that it is implemented in a single pass without multiple iterations. However, the non-separable transform matrix dimensions need to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes and R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {r}_{R 3} & … & {t}_{RN}\end{matrix} ]$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity, LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8, when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

There are totally 4 transform sets and 2 non-separable transform matrices (kernels) per transform set are used in LFNST. The mapping from the intra prediction mode to the transform set is predefined as shown in Table below. If one of the three CCLM modes (INTRA_LT_CCLM, INTRA_T_CCLM or INTRA_L_CCLM) is used for the current block (81<=predModelntra <=83), transform set 0 is selected for the current chroma block. For each transform set, the selected non-separable secondary transform candidate is further specified by the explicitly singaled LFNST index. The index is signaled in a bit-stream once per Intra CU after transform coefficients.

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

Since LFNST is restricted to be applicable only if all coefficients outside the first coefficient subgroup are non-significant, LFNST index coding depends on the position of the last significant coefficient. In addition, the LFNST index is context coded but does not depend on intra predication mode, and only the first bit is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), and LFNST index search could increase data buffering by four times for a certain number of decode pipeline stages. Therefore, the maximum size that LFNST is allowed, is restricted to 64×64. It is to be noticed that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

Scalable video coding refers to coding structure where one bitstream can contain multiple representations of the content e.g., at different bitrates, resolutions, or frame rates. In these cases, the receiver can extract the desired representation depending on its characteristics (e.g., resolution that matches best the display device). Alternatively, a server or a network element can extract the portions of the bitstream to be transmitted to the receiver depending on e.g., the network characteristics or processing capabilities of the receiver.

Scalable video coding may be realized through multi-layered coding. Multi-layered coding is a concept wherein an un-encoded visual representation of a scene is, by processes such as transformation and filtering, mapped into multiple dependent or independent representations (called layers). One or more encoders are used to encode a layered visual representation. When the layers contain redundancies, the use of a single encoder can, by using inter-layer prediction techniques, encode with a significant gain in coding efficiency. Layered video coding is typically used to provide some form of scalability in services—e.g., quality scalability, spatial scalability, temporal scalability, and view scalability.

Temporal scalability may be treated differently compared to other types of scalability. A sublayer, a sub-layer, a temporal sublayer, or a temporal sub-layer may be defined to be a temporal scalable layer (or a temporal layer, TL) of a temporally scalable bitstream. Each picture of a temporally scalable bitstream may be assigned with a temporal identifier, which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

Inter prediction may involve referring to sample locations outside picture boundaries (a.k.a. out-of-border (OOB)), i.e., a motion vector in inter prediction may point to outside of picture boundaries, at least for (but not necessarily limited to) the following two reasons. First, the location of a prediction block corresponding to a motion vector used in inter prediction may be partially or entirely outside picture boundaries. Second, a prediction block corresponding to a motion vector used in inter prediction may include a non-integer sample location that is within picture boundaries but for which the sample value is interpolated using filtering that takes input samples from locations that are outside picture boundaries.

In order to allow motion vectors pointing outside picture boundaries, existing codecs, such as HEVC and VVC, obtain samples outside picture boundaries by effectively replicating samples on the picture boundaries. Samples on the left and right picture boundaries are horizontally replicated to the OOB samples on the left and right sides of the picture, respectively. Samples on the top and bottom picture boundaries are vertically replicated to the OOB samples above and below the picture, respectively. Such a replication may be called “padding”. Such extension of the reference picture allows the motion compensation process to point to OOB area hence improving the prediction efficiency. However, since the extended area is effectively filled with padded samples and these padded samples do not represent the actual texture behaviour of the video, the motion compensation performance is still sub-optimal when using such samples for prediction.

An independent VVC subpicture is treated like a picture in the VVC decoding process. A motion vector pointing outside the boundaries of an independent subpicture causes replicating of boundary samples of the subpicture. Moreover, for an independent VVC subpicture it may additionally be required that loop filtering across the boundaries of an independent VVC subpicture is disabled. Boundaries of a subpicture are treated like picture boundaries in the VVC decoding process when sps_subpic_treated_as_pic_flag [i] is equal to 1 for the subpicture. Loop filtering across the boundaries of a subpicture is disabled in the VVC decoding process when sps_loop_filter_across_subpic_enabled_pic_flag [i] is equal to 0.

The mechanism to effectively replicate boundary samples to OOB samples in the inter prediction process may be implemented in multiple ways. One way is to allocate a sample array that is larger than the decoded picture size, i.e. has margins on top of, below, on the right side, and on the left side of the image. In addition to or instead of using such margins, the location of a sample used for prediction (either as input to fractional sample interpolation for the prediction block or as a sample in the prediction block itself) may be saturated so that the location does not exceed the picture boundaries (with margins, if such are used). Some of the video coding standards describe the support of motion vectors over picture boundaries in such manner.

In 360-degree panoramic video and in some projection formats of omnidirectional video, the sample value(s) from the opposite side of the picture can be used instead of using replicated boundary sample(s) when a sample horizontally outside the picture boundary is needed in an inter prediction process. Such a prediction mode may be referred to as wraparound motion compensation.

The present embodiments relate to various examples for handling the out-of-border (OOB) areas with samples when motion vectors point to such areas outside of picture in motion compensation process.

In some embodiments, the out-of-border areas are padded with samples that are replicated according to the motion vector direction(s) instead of traditional replication padding in horizontal or vertical direction.

In some embodiments, the samples in out-of-border areas are predicted or extrapolated by intra prediction methods using the decoded samples inside the picture. In such embodiment, the OOB area may be divided into M×N blocks, where M is the number of samples in the extended ore OOB area and N is the size of the other dimension of the block.

In some embodiments, intra prediction is used from the decoded samples of the current block and the intra predicted samples are used as replacement of the areas falling into the OOB area in motion compensated block.

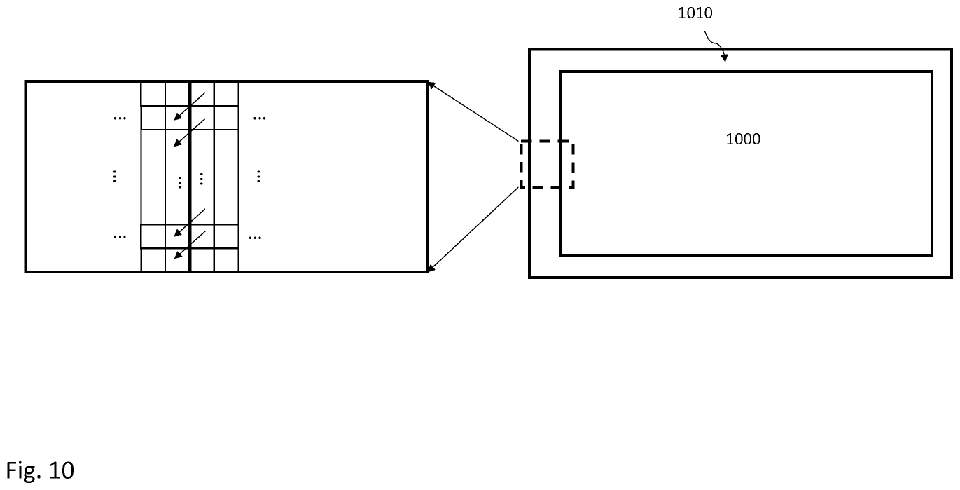

FIG. 10 illustrates an example process where samples in the OOB area 1010 are predicted with intra prediction using decoded samples in the picture 1000.

According to an embodiment, the desired intra prediction mode(s) for predicting the samples in the OOB area can be decided using texture analysis methods. For example, a texture analysis mechanism such as DIMD can be applied to the decoded samples in the picture for determining the intra prediction mode(s).

According to an embodiment, the desired intra prediction mode(s) for predicting the samples in the OOB area can be decided using a template-based intra derivation methods. For example, template-based methods such as TIMD can be applied to the decoded samples in the picture for determining the intra prediction mode(s).

According to an embodiment, the final prediction of samples in the OOB areas may be done by combining two or more different intra predictions using certain weights. One or more of the following methods may be available and/or may be used for encoding and/or decoding:
The weight values for each prediction can be pre-defined.
The weight values may be selected among pre-defined values, and an encoder may signal the associated index in or along a bitstream, and respectively a decoder may decode the associated index from or along a bitstream.
The weight values can be signaled, e.g. by an encoder, in or along a bitstream, and respectively the weight values can be decoded, e.g. by a decoder, from or along a bitstream.
The weight values can be derived in the encoder and decoder side.

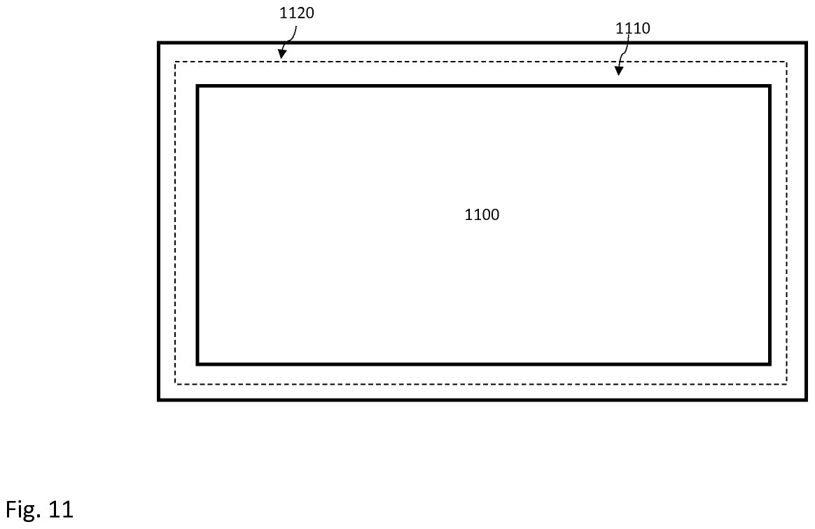

According to an embodiment, shown in FIG. 11, the intra prediction may be used for predicting samples only for a portion 1110 of the OOB area with intra prediction using decoded samples in the picture 1100. The remaining parts 1120 may be horizontally or vertically padded with the last predicted sample, similarly to how picture boundary samples are used for padding outside picture boundaries in published coding standards, such as VVC. According to an embodiment, when sample in a remaining part (subsequently “corner sample”) 1120 has both vertically and horizontally adjacent samples in the intra-predicted OOB area 1110, the sample value of the corner sample is derived to be a weighted sum of the sample values of the adjacent samples, where the weights may be inverse-proportional to the spatial distance from the corner sample to the adjacent samples.

According to an embodiment, cross-component prediction methods such as CCLM or CCCM may be used for predicting samples for the OOB area. The model parameters can be derived for example using the decoded samples in the current frame and reference channel, then the intra predicted samples in the OOB area of the reference channel can be used for predicting the samples in the OOB area of the current channel with the derived parameters.

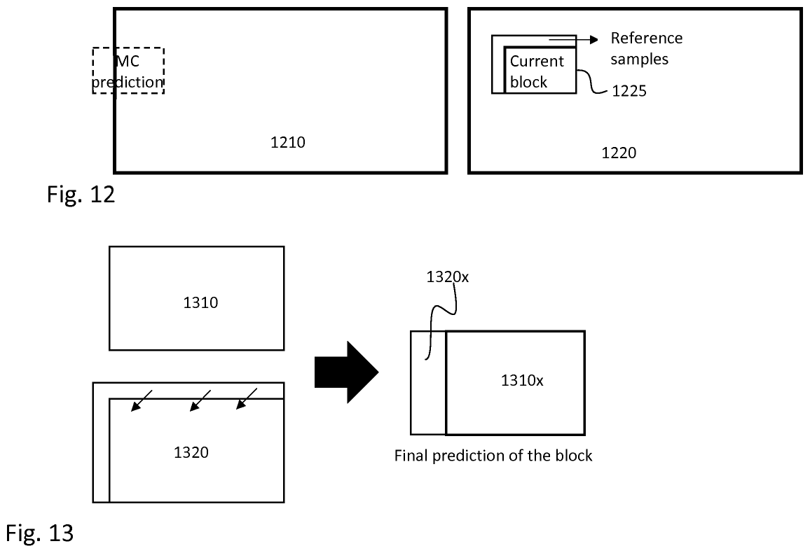

According to an embodiment, in the motion compensation (MC) process, the area of the block that falls in the OOB area may be predicted using intra prediction from the reference samples of the current block 1225 in current frame 1220. FIG. 12 illustrates an example when the motion vector of the block point to OOB areas in the reference frame 1210. FIG. 13 illustrates an example of using intra predicted samples 1320, from neighboring reference samples, for the areas of the block that falls in the OOB in reference frame and the remaining part of the block is filled with motion compensated prediction 1310.

According to an embodiment, the border samples between intra prediction 1320X and MC prediction 1310X (FIG. 13) in the final prediction may be filtered to generate smoother prediction for the block. For example, a blending operation of intra and inter predicted samples may be applied.

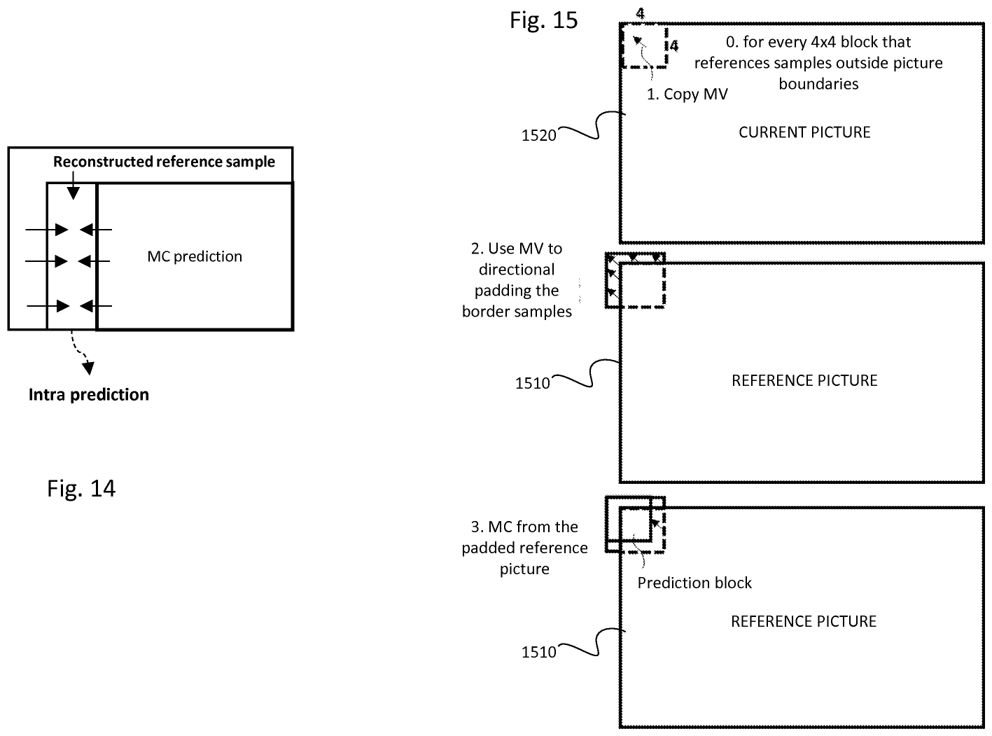

According to an embodiment, the intra prediction may use motion compensated samples along with the reconstructed reference samples from the neighborhood of the block. FIG. 14 illustrates an example, where motion compensated samples are used along with the reconstructed reference samples from the neighborhood for bi-intra prediction of the area that falls in OOB in motion compensated process.

In an alternative embodiment, the intra prediction may be obtained using only the reconstructed reference samples from the neighborhood of the current block, and the motion compensated samples may be used for filtering the intra predicted samples.

According to an embodiment, the intra prediction used for predicting the area of the block that falls in the OOB area may be a fixed mode, or it can be decided using a rate-distortion optimization associated with signalling the best performing mode for each block, or alternatively it can be determined using texture analysis methods (e.g., DIMD) or template-based methods (e.g., TIMD).

According to an embodiment, the intra prediction of the described area can be obtained by combining two or more intra prediction methods.

According to an embodiment, when bi-prediction motion compensation is used, and only one of the motion vectors point to the OOB area, then the samples of the second motion compensated prediction may be also used for intra prediction process.

According to an embodiment, the OOB area samples of a reference picture may be modified when a subsequent picture is encoded or decoded. When the subsequent picture is encoded or decoded, the motion vector directions of the boundary blocks of the subsequent picture are used to derive prediction direction to pad the reference picture directionally with intra prediction or alike.

According to an embodiment, the modification of OOB area samples of a reference picture is invoked by a subsequent picture provided that the reference picture fulfils certain requirements, which may include but are not necessarily limited to one or more the following:
The reference picture has a certain pre-defined picture type. For example, the reference picture is an intra random access point (IRAP) picture as defined in VVC or a key frame as defined in AV1.
The reference picture has a certain picture type indicated in or along a bitstream, or decoded from or along a bitstream.
The reference picture has a certain pre-defined coding type. For example, the reference picture is an intra frame or all slices of the reference picture are intra slices.
The reference picture has a certain coding type indicated in or along a bitstream, or decoded from or along a bitstream.

According to an embodiment, the modification of OOB area samples of a reference picture may be performed when encoding or decoding a single particular subsequent picture (subsequently called the current picture), provided that the current picture fulfils certain requirements, which may include but are not necessarily limited to one or more the following:
The current picture is the first succeeding picture in the lowest temporal sublayer (denoted TL0), in decoding order, that follows the reference picture. In this case, the reference picture is also in the lowest temporal sublayer.
The current picture is the first succeeding picture, in decoding order, that follows the reference picture and is in the same temporal sublayer as the reference picture.
The current picture uses the reference picture as a reference for inter prediction.

According to an embodiment, the modification of OOB area samples of a reference picture may be performed repetitively when encoding or decoding subsequent pictures, provided that the subsequent pictures fulfil certain requirements, which may include but are not necessarily limited to one or more the following:
The subsequent picture follows the reference picture in decoding order, and has a lower temporal identifier value that any other picture following the reference picture in decoding order prior to this subsequent picture.
The subsequent picture uses the reference picture as a reference for inter prediction.

The above-described embodiments on performing the modification of OOB area samples of a reference picture based on qualifying the reference picture or the subsequent picture may also be combined. In other words, when both the reference picture and the subsequent picture fulfil certain requirements as described in the above embodiments, the OOB area samples of the reference picture are modified.

According to an embodiment, in case the boundary block is coded in intra mode, motion vector(s) of a block in the vicinity of the intra coded block may be used for directional padding. It may be an immediate neighboring block of that intra coded boundary block, or it may be the first inter coded block in certain distance and direction of the intra coded boundary block. The vicinity area may be defined in the coding standard; for example, it could be one or more CTUs, tiles or slices. In another example, if the boundary block is coded in intra mode, the directional padding may follow the intra prediction direction of that intra coded block.

The width or height of the directionally padded areas can be selected according to the motion vector magnitudes, or can be hard-coded (e.g., to 64).

In some examples, samples that have already been directionally padded may be subject to another directional padding. According to an embodiment, such samples are overwritten with the new directional padding. According to an embodiment, the outcome of the directional paddings may be blended to form sample values for samples within an OOB area.

FIG. 15 illustrates an example embodiment of directionally padding the OOB area with samples in a reference picture 1510. When a block at the picture boundary is encoded, the following steps are performed for each subblock (such as 4×4 block) for which such a motion vector is derived that references samples in the OOB areas of the reference picture 1510. In the process, for every block (such as 4×4 block) that references samples outside the picture boundaries, a motion vector is copied. The motion vector is used to directionally pad the border samples in the reference picture. The motion compensation is performed from the padded reference picture.

It is to be noticed in encoding that this process may be applied multiple times for candidate motion vectors among which the encoder is selecting. Likewise, when a block at the picture boundary is decoded, the following steps are performed for each subblock for which such a motion vector is derived that references samples in OOB areas of the reference picture 1510
1. The motion vector is used to derive a directional intra prediction mode or alike.
2. The derived intra prediction mode or alike is used to pad border samples of the reference picture directionally to the OOB areas of the reference picture.
3. The prediction block for motion compensation of the subblock being encoded or decoded is formed using the reference picture with OOB areas having directionally padded samples.

According to an embodiment, the motion vector directions of the boundary blocks may be considered when using intra prediction for the OOB area samples in a way that the angular intra modes with the same or close direction are motion vectors are used for predicting the samples.

According to an embodiment, one or more of the described embodiments may be individually or jointly used for handling the out-of-border samples in motion compensation.

According to an embodiment, the solution described in any other embodiment(s) can be applied to borders of tiles, subpictures and/or slices, where their corresponding borders when they are configured in a way that they can be decoded independently while the motion vectors are allowed to point to OOB areas. For example, when sps_subpic_treated_as_pic_flag [i] is indicated or inferred to be equal to 1 as in VVC, the subpicture boundaries are treated like picture boundaries according to any described embodiment.

According to an embodiment, the number of padded samples (i.e., the width and height of the OOB area) is predefined. According to an embodiment, the width and/or height of the OOB area is indicated in or along the bitstream e.g., in channel, picture or sequence level. According to an embodiment, an encoder indicates the width and/or height of the OOB area in or along a bitstream, for example in a picture parameter set or a sequence parameter set. The width and/or height may be indicated separately or jointly for all borders (i.e., single value that applies to both the width and the height), separately for horizontal and vertical boundaries, or separately for top, bottom, left and right boundaries. The width and/or height may be indicated jointly for all independent regions for which OOB sample derivation applies or separately on independent region basis. Likewise, in an embodiment, a decoder decodes the width and/or height value(s) of the OOB area(s) from or along a bitstream, such as from a picture parameter set or a sequence parameter, and applies them accordingly in decoding. Controlling the width and/or height of the OOB areas may be used to limit the memory usage, which may be beneficial for example, when embodiments are applied to independent regions, such as independent subpictures.

According to an embodiment, different methods for padding OOB areas are determined to be used for different borders. The padding method for a specific border can be signaled in the bitstream. For example, it can be signaled that texture analysis based out-painting is used for left and right borders, while closest available sample based padding is used for top and bottom borders.

According to an embodiment, the use of horizontal wraparound motion compensation is enabled and indicated in a bitstream by an encoder (e.g., with pps_ref_wraparound_enabled_flag equal to 1 as in VVC, or similarly), or decoded from a bitstream by a decoder. When horizontal wraparound motion compensation is in use, the horizontal sample padding for the OOB areas is turned off, and sample padding described in the present embodiments is applied only to OOB areas above or below the top and bottom boundaries. This may reduce the memory usage in implementations.

According to an embodiment, if a motion vector points to an area outside of a first reference image, the motion vector is inverted by changing the signs of its horizontal and vertical motion vector components, and second reference image is selected from a different temporal direction compared to the first reference image. In addition to inverting the motion vector, it may also be scaled depending on the temporal distances of the first and the second reference images from the current image. The decision to invert a motion vector may be configured to depend on the size of the area falling outside of the first reference image that is required for predicting the block.

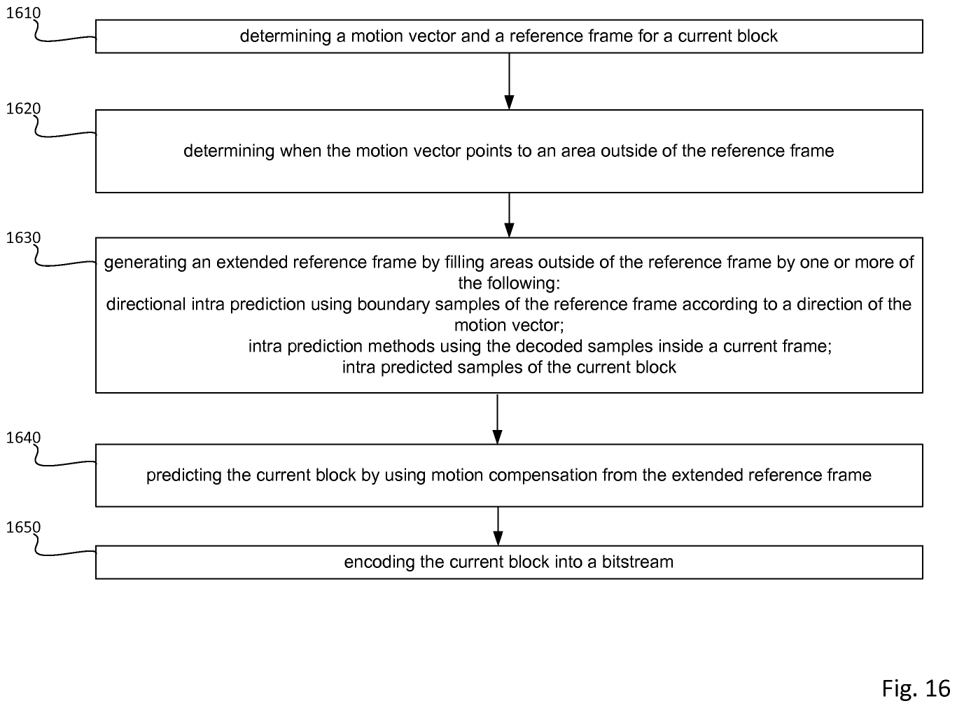

The method according to an embodiment is shown in FIG. 16. The method generally comprises determining 1610 a motion vector and a reference frame for a current block; determining 1620 when the motion vector points to an area outside of the reference frame; generating 1630 an extended reference frame by filling areas outside of the reference frame by one or more of the following:
directional intra prediction using boundary samples of the reference frame according to a direction of the motion vector;
intra prediction methods using decoded samples inside a current frame;
intra predicted samples of the current block;

predicting 1640 the current block by using motion compensation from the extended reference frame; and encoding 1650 the current block into a bitstream. Each of the steps can be implemented by a respective module of a computer system.

An apparatus according to an embodiment comprises means for means for determining a motion vector and a reference frame for a current block; means for determining when the motion vector points to an area outside of the reference frame; means for generating an extended reference frame by filling areas outside of the reference frame by one or more of the following
directional intra prediction using boundary samples of the reference frame according to a direction of the motion vector;
intra prediction methods using decoded samples inside a current frame;
intra predicted samples of the current block;

means for predicting the current block by using motion compensation from the extended reference frame; and means for encoding the current block into a bitstream.

The means comprises at least one processor, and a memory including a computer program code, wherein the processor may further comprise processor circuitry. The memory and the computer program code are configured to, with the at least one processor, cause the apparatus to perform the method of FIG. 16 according to various embodiments.

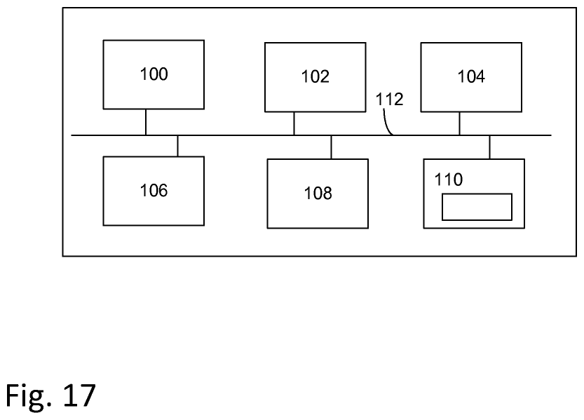

An example of a data processing system for an apparatus is illustrated in FIG. 17. Several functionalities can be carried out with a single physical device, e.g., all calculation procedures can be performed in a single processor if desired. The data processing system comprises a main processing unit 100, a memory 102, a storage device 104, an input device 106, an output device 108, and a graphics subsystem 110, which are all connected to each other via a data bus 112.

The main processing unit 100 is a conventional processing unit arranged to process data within the data processing system. The main processing unit 100 may comprise or be implemented as one or more processors or processor circuitry. The memory 102, the storage device 104, the input device 106, and the output device 108 may include conventional components as recognized by those skilled in the art. The memory 102 and storage device 104 store data in the data processing system 100.

Computer program code resides in the memory 102 for implementing, for example, a method as illustrated in a flowchart of FIG. 16 according to various embodiments. The input device 106 inputs data into the system while the output device 108 receives data from the data processing system and forwards the data, for example to a display. The data bus 112 is a conventional data bus and while shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet tablet computer.

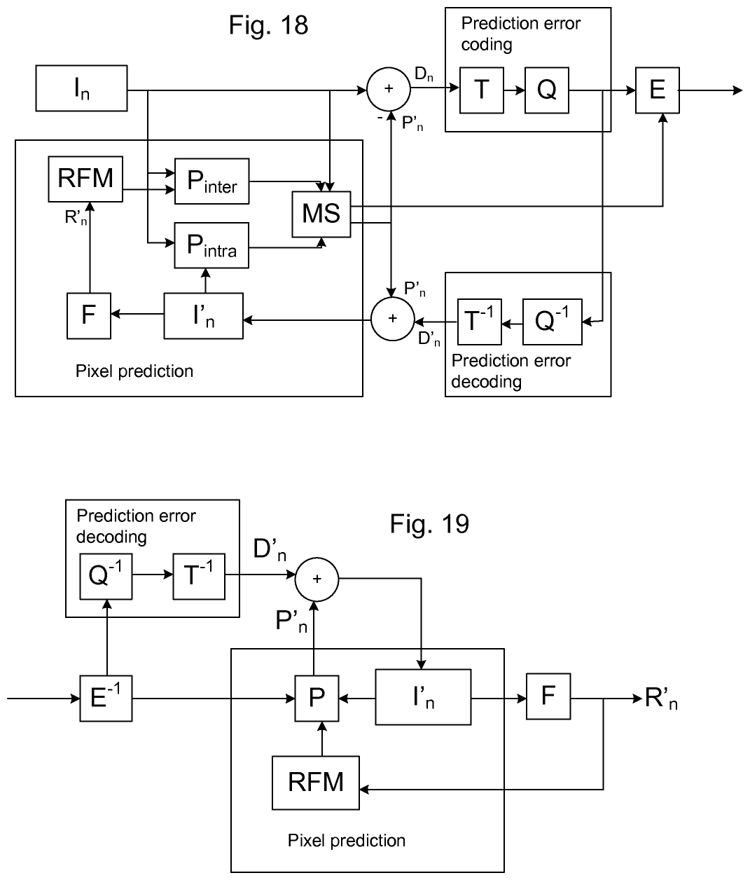

FIG. 18 illustrates an example of a video encoder, where In: Image to be encoded; P′ₙ: Predicted representation of an image block; Dn: Prediction error signal; D′ₙ: Reconstructed prediction error signal; I′ₙ: Preliminary reconstructed image; R′ₙ: Final reconstructed image; T, T⁻¹: Transform and inverse transform; Q, Q⁻¹: Quantization and inverse quantization; E: Entropy encoding; RFM: Reference frame memory; Pinter: Inter prediction; Pintra: Intra prediction; MS: Mode selection; F: Filtering. FIG. 19 illustrates a block diagram of a video decoder where P′ₙ: Predicted representation of an image block; D′ₙ: Reconstructed prediction error signal; I′ₙ: Preliminary reconstructed image; R′ₙ: Final reconstructed image; T⁻¹: Inverse transform; Q⁻¹: Inverse quantization; E⁻¹: Entropy decoding; RFM: Reference frame memory; P: Prediction (either inter or intra); F: Filtering. An apparatus according to an embodiment may comprise only an encoder or a decoder, or both.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiment.

The present solution provides advantages. For example, the present embodiments improves the motion compensation efficiency when the motion vectors are pointing to areas outside of the picture boundary in reference frame(s).

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-13. (canceled)

14. An apparatus comprising at least one processor; and at least one memory storing instructions that, when executed with the at least one processor, cause the apparatus to:
determine a motion vector and a reference frame for a current block;
generate an extended reference frame by filling areas outside of the reference frame by one or more of the following:
directional intra prediction using boundary samples of the reference frame according to a direction of the motion vector;
intra prediction methods using decoded samples inside a current frame; or
intra predicted samples of the current block;
predict the current block by using motion compensation from the extended reference frame; and
encode the current block into a bitstream.

15. The apparatus according to claim 14, wherein the instructions, when executed with the at least one processor, cause the apparatus to determine the intra prediction methods by using a texture analysis method.

16. The apparatus according to claim 15, wherein the texture analysis method is a decoder side intra mode derivation method.

17. The apparatus according to the claim 14, wherein the instructions, when executed with the at least one processor, cause the apparatus to determine the intra prediction methods by using a template based intra mode derivation method.

18. The apparatus according to claim 14, wherein the instructions, when executed with the at least one processor, cause the apparatus to predict samples for areas outside of a picture by cross-component prediction, wherein samples in the areas outside of the picture in a reference channel are used for predicting samples for the areas outside of the picture in a current channel.

19. The apparatus according to the claim 14, wherein the instructions, when executed with the at least one processor, cause the apparatus to filter border samples between the intra prediction and a motion compensation prediction in a final prediction.

20. A method comprising:
determining a motion vector and a reference frame for a current block;
generating an extended reference frame by filling areas outside of the reference frame by one or more of the following
directional intra prediction using boundary samples of the reference frame according to a direction of the motion vector;
intra prediction methods using decoded samples inside a current frame; or
intra predicted samples of the current block;
predicting the current block by using motion compensation from the extended reference frame; and
encoding the current block into a bitstream.

21. The method according to claim 20, further comprising determining the intra prediction methods by using a texture analysis method.

22. The method according to claim 21, wherein the texture analysis method is a decoder side intra mode derivation method.

23. The method according to claim 20, further comprising determining the intra prediction methods by using a template based intra mode derivation method.

24. The method according to claim 20, further comprising predicting samples for areas outside of a picture by cross-component prediction, wherein samples in the areas outside of the picture in a reference channel are used for predicting samples for the areas outside of the picture in a current channel.

25. The method according to claim 20, further comprising filtering border samples between the intra prediction and a motion compensation prediction in a final prediction.

26. A non-transitory computer-readable medium comprising program instructions stored thereon which, when executed with at least one processor, cause the at least one processor to:
determine a motion vector and a reference frame for a current block;
generate an extended reference frame by filling areas outside of the reference frame by one or more of the following
directional intra prediction using boundary samples of the reference frame according to a direction of the motion vector;
intra prediction methods using decoded samples inside a current frame;
intra predicted samples of the current block;
predict the current block by using motion compensation from the extended reference frame; and
encode the current block into a bitstream.

27. The computer program product according to claim 26, wherein the program code portions further configured, upon execution to: determine the intra prediction methods by using a texture analysis method.

28. The computer program product according to claim 26, wherein the texture analysis method is a decoder side intra mode derivation method.

29. The computer program product according to the claim 26, wherein the program code portions further configured, upon execution to:
determine the intra prediction methods by using a template based intra mode derivation method.

30. The apparatus according to claim 26, wherein the program code portions further configured, upon execution to:
predict samples for areas outside of a picture by cross-component prediction, where samples in the areas outside of the picture in a reference channel are used for predicting samples for the areas outside of the picture in a current channel.

31. The apparatus according to the claim 26, wherein the program code portions further configured, upon execution to:
filter border samples between the intra prediction and a motion compensation prediction in a final prediction.
